(19) United States
(12) Patent Application Publication
(10) Pub. No.: US 2009/0180701 A1
(43) Pub. Date: Jul. 16, 2009

(54) Video Data Encoding System

(76) Inventor: Seungyeob Choi, Los Angeles, CA (US)

Correspondence Address: PARK LAW FIRM, 3255 WILSHIRE BLVD, SUITE 1110, LOS ANGELES, CA, 90010, US

(21) Appl. No.: 11/972,527

(22) Filed: Jan. 10, 2008

(51) Int. Cl. G06K 9/46

(52) U.S. Cl. 382/236

(57) ABSTRACT

A video data encoding system for video data having a plurality of video frames, predetermined number of which are provided per unit time, is provided. The system includes an encoder that processes the video frames. Each of the video frames comprises one I-subframe and one P-subframe. The I-subframes in a predetermined number of sequential video frames have a predetermined spatial relationship with one another. The spatial relationship of the I-subframes can be defined such that I-subframes are moving across frames in one direction. Alternatively, spatial relationship of the I-subframes can be arranged in randomly selected order. A video data encoding method includes steps of forming I-subframes and P-subframes, and inserting the I-subframes in a predetermined number of sequential video frames. The I-subframes in the predetermined number of sequential video frames have a predetermined spatial relationship with one another.

### BACKGROUND OF THE INVENTION

The present system relates to video data encoding system and, more particularly, a video data encoding system that divides a video frame into a pair of sub-frames and applies different encoding modes to each sub-frame to thereby avoid the need of periodic insertion of intra-coded frames and thus minimize the variation in size of data over frames.

In a video compression system, each video frame is compressed in either intra-frame or inter-frame coding mode. Frames that are compressed in intra-frame coding mode are called intra-frames (or I-frames) and contain the entire data that are needed to reconstruct a frame. Frames that are compressed in inter-frame coding mode are called inter-frames (or P-frames) and contain only the changes between a reference frame and the current frame. In general, the size of an inter-frame is significantly smaller compared to its intra-coded equivalent. However, since inter-frames do not contain the complete data to reconstruct a frame, a decoder needs a reference frame (or reference frames) to decode an inter-coded frame.

In addition to I- and P-frames, recent video encoders adopt another type of frames, called B-frames. B-frames are created by calculating the changes between frames, which is similar to P-frames. The difference between P- and B-frames is that B-frames use reference frames from both forward (which is a future frame) and backward directions (a past frame), while P-frames makes use of reference frames from backward direction. On the one hand, the use of B-frames can further reduce the size of data. On the other hand, using a reference frame from both directions requires a larger buffer to maintain the amount of data that is needed for the bi-directional prediction, and thus it increases the overall delay in the process of encoding and decoding video data. Since P-frames and B-frames can be considered indifferent in that they have been encoded using a reference frame (or reference frames) and cannot be decoded on their own, throughout this document P-frame is simply used to refer to both P- and B-frames.

Although the size of data is smaller in inter-frame coding, most video encoders periodically insert I-frames and do not depend solely on inter-frame coding for the entire sequence of video frames. The reason is because video data consisting of only P-frames would have the following problems.

One of the problems is that it would be extremely difficult or inefficient to enable a random access to a point of video if the entire video consisted of only P-frames. When a user is allowed to access a point in a video stream, it is not possible to reconstruct the original frame using the data available at the point where the user accesses. An advanced decoder may backtrack to the very first frame and decode every frame before the point of access in order to calculate a reference frame. However, this approach would be theoretically possible, but it is practically not feasible to backtrack to the very first frame of a video and decode all frames in between the first frame and the frame at the point of access.

A second problem is that some frames may be lost before they arrive at the decoder. It is especially the case in applications of media streamed over the internet where the video data are recorded and encoded on a broadcasting station, transmitted to an endpoint (receiver) through the public internet, and decoded and played on the receiver's computer. Due to the heterogeneous nature of the internet, it is unfortunately unavoidable that some data are delivered late or sometimes being lost. If a frame is lost, the decoder fails to generate a reference frame to be used to decode the next frame. Without a reference frame, the decoder may not correctly decode any subsequent frames after the lost frame unless another intra-frame is given. Some decoders simply reuse the most recently used reference frame—which is the frame before the missing frame—and it causes quality degradation in video.

For the above mentioned reasons, the standard techniques periodically insert intra-frames every n seconds where n is a predefined parameter (refer to FIG. 1). When a user accesses a point in a video, the player only needs to backtrack to the previous intra-frame, which is n seconds or shorter. For instance, if a video is captured at the rate of 15 frames per second and intra-frames are inserted every 2 seconds, the maximum length the decoder needs to backtrack is around 1.93 second (29 frames). In a similar way, when the video is broadcast in real-time and a packet is lost during the transmission, the degraded video only lasts for maximum 1.93 second and can be fixed when the next intra-frame is received.

Although the periodic insertion of intra-frame is a useful method, it results in a large variation over the data size of frames and therefore the usage of bandwidth becomes irregular. Typically, intra-frames are significantly larger than inter-frames (a frame can easily be 20 to 30 times larger in intra-frame mode than in inter-frame mode), which means that, suppose the video data are captured at the rate of 15 frames per second and intra-frames are inserted every 2 seconds, one very large frame is created and transmitted every 2 seconds, while the other 29 frames during the remaining 2 seconds are relatively small. In other words, more than half of storage (in archiving applications) or bandwidth (in real-time broadcasting applications) are consumed by 3% of the video and only less than half are consumed by the rest 97%. This makes the following problem.

In a real-time broadcasting application, an IP packet must be less than 1,500 bytes since the maximum transmission unit (MTU) of IP-network is typically 1,500 bytes. Any video frames that are bigger than that have to be split into smaller segments and transmitted separately. Even if only one of the segments is lost, the decoder may not decode the frame and have to discard the entire frame. In practice, if a CIF-sized (352 by 288 pixels) video is encoded using H.263 (one of the popular video encoding algorithms for video conferencing), a typical intra-frame is split into 20 to 30 segments in order to fit into 1,500-byte IP-packets. A typical inter-frame can fit into only one or two packets. As a result, when the network capacity is not sufficient for an error-free transmission and some portion of data are lost during transmission, it is likely that the frames that fail to be delivered are mostly intra-frames. If a typical intra-frame is 30 times bigger than a typical inter-frame, the intra-frame has 30 times higher possibility of being lost.

It is the nature of the internet or IP-network where data are transmitted through a packet-based network (as opposed to circuit-based network) that some packets may be delivered late or damaged, or even get lost before they arrive the destination. If the amount of data is increased, the chance of losing some of the packets during the transmission is also increased. One of the major causes of video degradation is that intra-frames repeatedly fail to be delivered due to their excessively large quantity of data while other inter-frames are delivered without loss. In that case, the receiver may not have a chance to create a reference frame, and as a result, incorrectly built reference frames have to be used for a longer period of time. Therefore, the overall quality of video can be improved if the amount of data is evenly distributed across frames, of which the method is presented by the invention.

### SUMMARY OF THE INVENTION

The present invention contrives to solve the disadvantages of the prior art.

An objective of the invention is to provide a video data encoding system and method that eliminates the need of encoding an entire frame in intra-frame coding mode and as a result reduces frame loss due to excessively large amount of data in transmission over network.

Another objective of the invention is to provide a video data encoding system and method that homogenizes video frame size for video frames that have I-frames and P-frames, which makes the usage of bandwidth more predictable.

The invention solves the above-mentioned problems by providing a system and method for splitting each frame into an I-subframe and a P-subframe and applying intra-frame coding to the I-subframe and inter-frame coding to the P-subframe. The I- and P-subframes are mutually exclusive, which means that any point in a frame is included in either I-subframe or P-subframe, but not both.

The area that is included in I-subframe is moving across frames, and after a certain period of time, every part of the entire area is included in I-subframe of at least one frame. The area of I-subframe can be moved toward a predefined direction (for instance, from the top left corner to the bottom right corner), or can be moved following a randomly selected path where the path covers the entire area during a predetermined cycle of time.

By applying intra-frame coding to a part of a frame, the resulting data size becomes slightly larger compared to the purely inter-frame coded frame. The intra-coded area is moving and a different area is defined as I-subframe in the next frame.

The present invention provides a video data encoding system in which video data comprises a plurality of video frames and predetermined number of the video frames are provided per unit time. The system comprises an encoder that processes the video frames.

The encoder comprises a mode controller that generates video frames. Each of the video frames comprises one I-subframe and one P-subframe. The I-subframes in a predetermined number of sequential video frames have a predetermined spatial relationship with one another.

The mode controller comprises a region queue that stores a set of geometrical data defining I-subframe in a frame.

The spatial relationship of the I-subframes between frames can be defined in such a way that I-subframe is moving in one direction across frames.

Alternatively, the special relationship can be defined such that I-subframes are arranged in randomly selected order across frames.

The present invention provides a video data encoding method which includes steps of forming I-subframes and P-subframes, and inserting the I-subframes at predetermined geometrical locations in a sequence of video frames. The I-subframes in adjacent video frames have a predetermined spatial relationship with one another.

In the method the spatial relationship of the I-subframes can be defined such that the I-subframe is moving in one direction. Alternatively, the spatial relationship of the I-subframes can be defined such that I-subframes are arranged in randomly selected order.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram that describes the mode controller in a conventional video encoder, wherein the controller periodically changes the mode such that every n-th frame is encoded using intra-coding mode;

FIG. 2 is a schematic diagram that describes a mode controller of the present invention, which specifies the areas to be encoded using intra- and inter-coding modes, respectively;

FIG. 3 is a schematic diagram that depicts the internal structure of the mode controller;

FIG. 4 is a schematic diagram showing an example of a video frame, wherein one area is marked as I-subframe and the other area is P-subframe;

FIG. 5 is a schematic diagram that depicts a method of moving the area of I-subframe in one direction; and

FIG. 6 is a schematic diagram that depicts an alternative method of moving the area by randomly selected order.

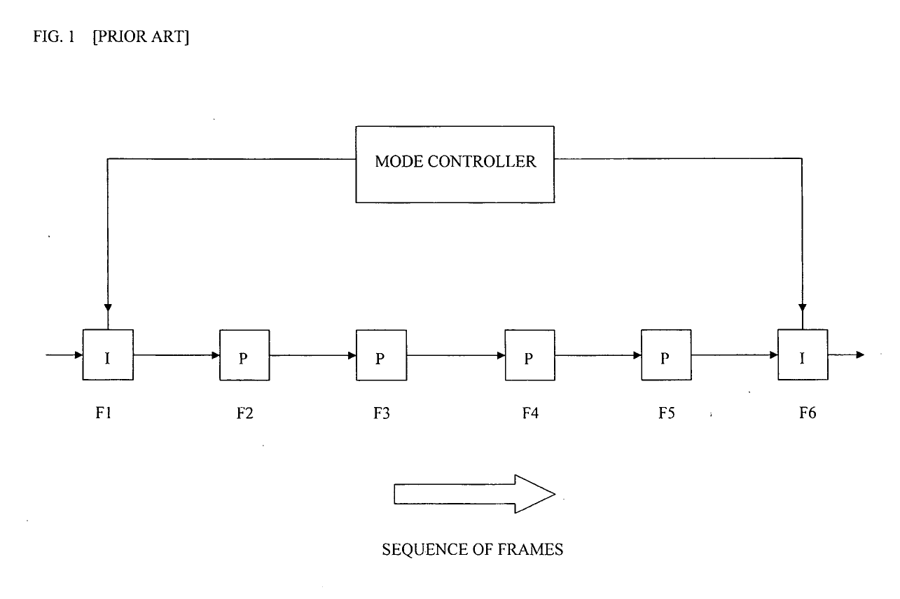

### DETAILED DESCRIPTION OF THE INVENTION

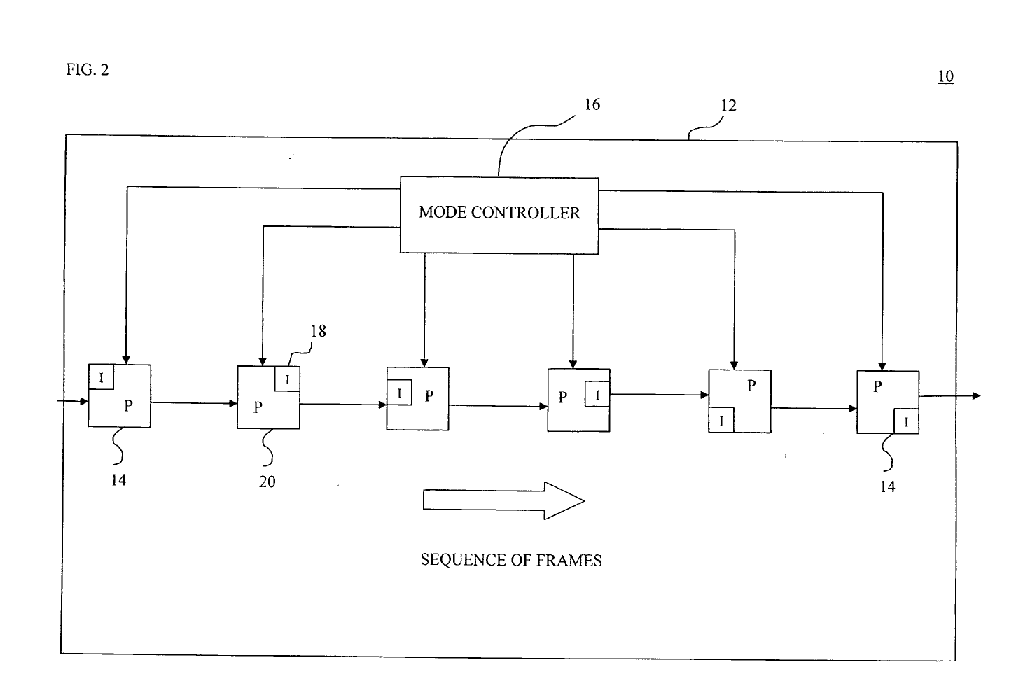

FIG. 2 shows a video data encoding system 10 in which video data comprises a plurality of video frames 14 and predetermined number of the video frames are provided per unit time. The system comprises an encoder 12 that processes the video frames 14. Video data taken by a video camera or camcorder is processed by the encoder 12 into a format suitable for network transmission.

The encoder 12 comprises a mode controller 16 that generates video frames 14. Each of the video frames 14 comprises one I-subframe 18 and one P-subframe 20. The I-subframes 18 in a predetermined number of sequential video frames 14 have a predetermined spatial relationship with one another. The encoder 12 splits the video data into I-subframes (reference frame) and P-subframes and processes each subframe using different encoding mode. The encoder distributes the I-subframes evenly on the predetermined number of sequential video frames 14.

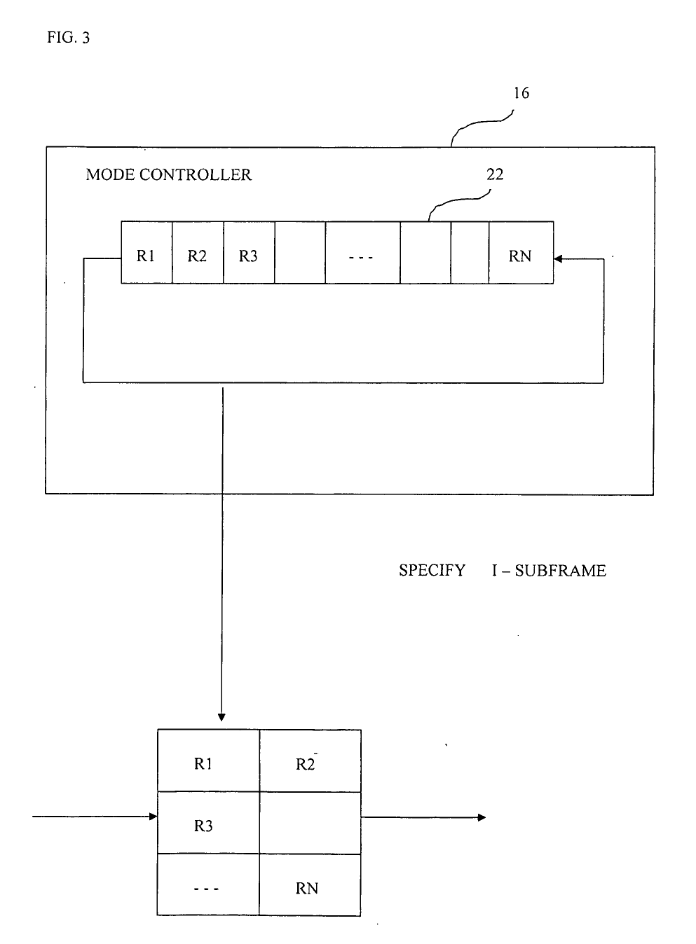

FIG. 3 shows that the mode controller 16 comprises a region queue 22 that stores a set of the I-subframes 18.

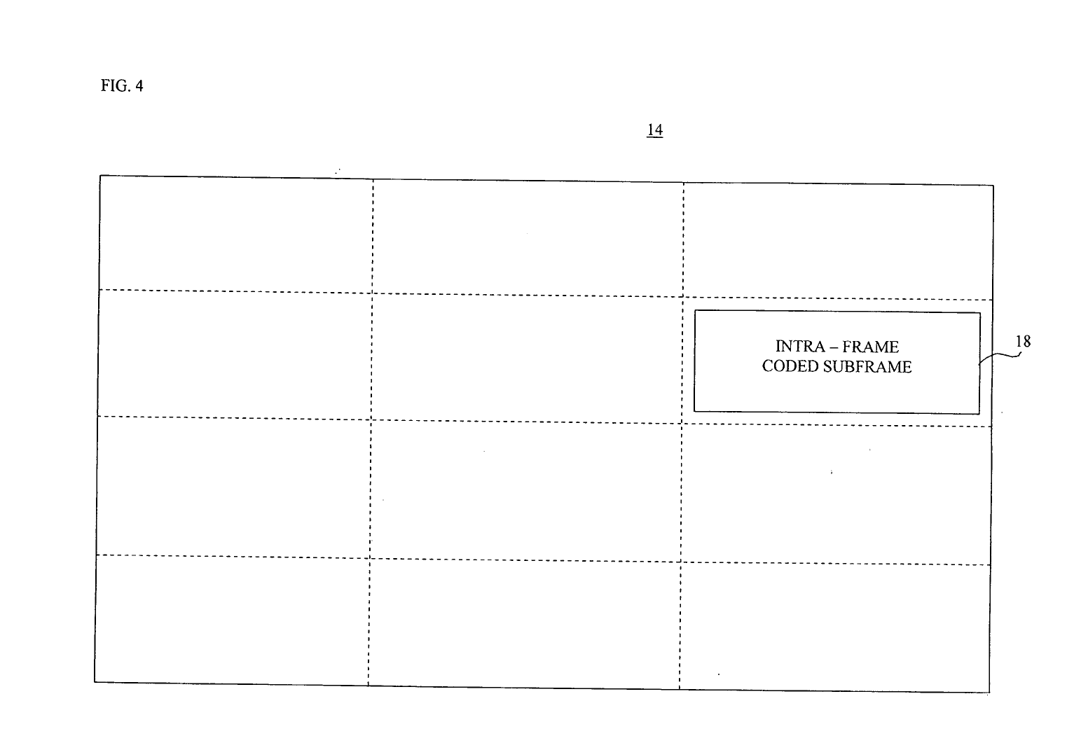

FIG. 4 shows an example of the video frame 14.

FIG. 5 shows that the spatial relationship of the I-subframes has the I-subframes 18 arranged in one direction.

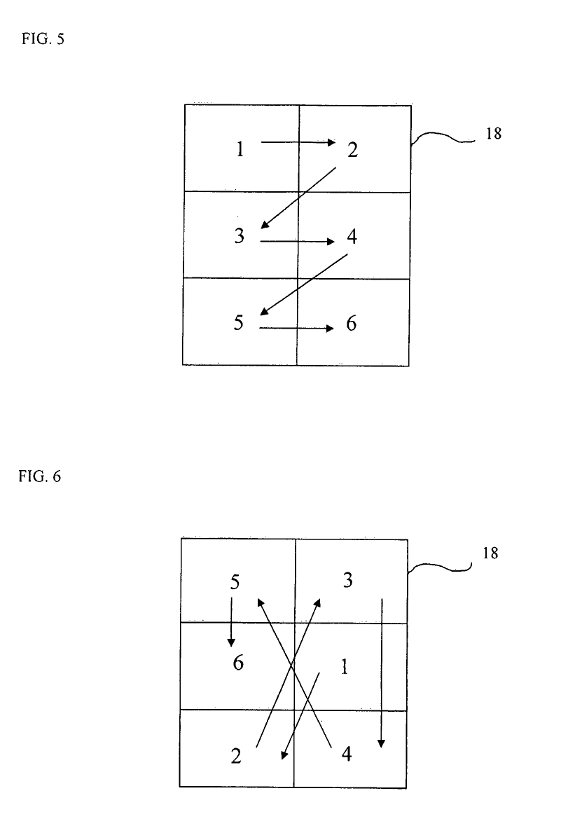

Alternatively, as shown in FIG. 6, spatial relationship of the I-subframes has the I-subframes 18 arranged in randomly selected order. The spatial relationship between the I-subframes across a sequence of frames may be adjusted for ease of encoding and/or decoding.

The present invention provides a video data encoding method which includes steps of forming I-subframes 18 and P-subframes 20, and inserting the I-subframes 18 in a predetermined number of sequential video frames 14. The I-subframes 18 in the predetermined number of sequential video frames 14 have a predetermined spatial relationship with one another.

The advantage of the method is that the resulting video stream does not need an explicit insertion of I-frame, because every part of a frame is encoded using an I-frame coding at least once during a cycle of time. When a frame is lost in transmission, a part of the reference frame is constructed by an I-subframe at a time, and after a full cycle of the I-subframe movement, eventually the entire reference frame is constructed.

The abolition of the explicit I-frames has the following advantages. It enables more efficient utilization of bandwidth. The amount of data to be transmitted through the IP-based network becomes more homogeneous over the sequence of video frames, and the bandwidth explosion becomes less frequent. Assuming that the capacity of bandwidth is unchanged, the quality of video becomes better if the bandwidth is better utilized. Since there is no more explicit I-frame, the video quality degradation due to the repetitive loss of frames with larger quantity is less existent.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A video data encoding system, wherein video data comprises a plurality of video frames, wherein predetermined number of the video frames are provided per unit time, the system comprising:
a) an encoder that processes the video frames;
wherein the encoder comprises a mode controller that generates video frames, wherein each of the video frames comprises one I-subframe and one P-subframe, wherein the I-subframes in a predetermined number of sequential video frames have a predetermined spatial relationship with one another.

2. The video data encoding system of claim 1, wherein the mode controller comprises a region queue that stores a set of geometrical locations for I-subframes.

3. The video data encoding system of claim 1, wherein the spatial relationship of the I-subframes has the I-subframes arranged in one direction.

4. The video data encoding system of claim 1, wherein the spatial relationship of the I-subframes has the I-subframes arranged in randomly selected order.

5. A video data encoding method, wherein video data comprises a plurality of video frames, wherein predetermined number of the video frames are provided per unit time, the method comprising steps of:
a) forming I-subframes and P-subframes; and
b) inserting the I-subframes in a predetermined number of sequential video frames;
wherein the I-subframes in the predetermined number of sequential video frames have a predetermined spatial relationship with one another.

6. The video data encoding method of claim 5, wherein the spatial relationship of the I-subframes has the I-subframes arranged in one direction.

7. The video data encoding method of claim 5, wherein the spatial relationship of the I-subframes has the I-subframes arranged in randomly selected order.
